(19) United States
(12) Patent Application Publication
(10) Pub. No.: US 2007/0130017 A1
(43) Pub. Date: Jun. 7, 2007

(54) Method and apparatus for providing restaurant services

(75) Inventors: Pedro Torres, Chuano (VE); Juan Carlos Horna, Chuano (VE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Baninvest Banco de Investment Corporation of Panama, Chuano (VE)

(21) Appl. No.: 11/297,254

(22) Filed: Dec. 7, 2005

(51) Int. Cl. G06Q 30/00

(52) U.S. Cl. 705/15

(57) ABSTRACT

According to one embodiment of the invention, a system is provided that provides services to a patron in a restaurant that enhances the dining experience. For example, one embodiment provides a method of providing information for use by a patron of a restaurant at a table of the patron by providing an interactive display for use at a table in a restaurant wherein the display is configured to be viewable by the patron when the patron is seated at the table; providing a graphical user interface for the interactive display accessible by the patron when the patron is seated at the table; configuring a first portion of the graphical user interface to display information for a local event schedule, wherein the first portion of the graphical user interface is selectable by the patron to display additional details for the local event schedule. Similarly, an apparatus can be provided that is configured to provide such capabilities as well.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

According to one embodiment of the invention, a system is provided to enhance the dining experience at a restaurant. For example, according to one embodiment of the invention, a hand-held device can be provided to a patron at a restaurant that allows the patron to obtain information while dining.

### BACKGROUND

When someone is dining at a restaurant rather than dining at home, they are cut off from normal resources that they would typically have available to them while at home. Similarly, for a business traveler in a foreign city, that particular traveler is less familiar with surrounding events and access to transportation. Moreover, there are some instances when a patron at a restaurant will want to be able to provide feedback to a waiter, maitre 'd, or manager.

For example, a business traveler in a foreign city is often unfamiliar with local theater or sporting event schedules. Since dining often precedes such events, and a patron at a restaurant is typically cutoff from access to papers, the internet, or a telephone, while dining the patron must frequently cut short the time spent at the restaurant in order to conservatively arrive at the theater in time. Alternatively, a patron at a restaurant may decide that he or she desires to take in a movie or play once dinner is completed. Therefore, access to local theater event schedules would assist the patron in choosing a showing that coincides with the patron completing his or her dinner. The same holds true for somebody who is interested in attending a sporting event.

As another example, a patron at a restaurant would like to be able to communicate with restaurant staff on an expedited basis. For example, a patron might like to know the total of their bill, request an additional cup of coffee, get the attention of the waiter when needed, or request the maitre 'd or manager to come to their table as well. At present, patrons must instead wait for a waiter to come serve them before such requests can be made. As a result, the dining experience for the patron can be frustrating when the patron is in a hurry.

As another example, for someone who is dining alone, such a dining experience can often be a boring experience if there is nothing to occupy the patron's mind. Not all restaurants currently provide a newspaper to patrons.

As a result, there are many situations where restaurant services could be improved by addressing any one of these problems.

### SUMMARY

According to one embodiment of the invention, a system is provided that provides services to a patron in a restaurant that enhances the dining experience. For example, one embodiment provides a method of providing information for use by a patron of a restaurant at a table of the patron by providing an interactive display for use at a table in a restaurant wherein the display is configured to be viewable by the patron when the patron is seated at the table; providing a graphical user interface for the interactive display accessible by the patron when the patron is seated at the table; configuring a first portion of the graphical user interface to display information for a local event schedule, wherein the first portion of the graphical user interface is selectable by the patron to display additional details for the local event schedule. Similarly, an apparatus can be provided that is configured to provide such capabilities as well.

Further embodiments will be apparent to those of ordinary skill in the art from a consideration of the following description taken in conjunction with the accompanying drawings wherein certain methods, apparatuses, and articles of manufacture for practicing the embodiments are illustrated. However, it is to be understood that the embodiments are not limited to the details disclosed, but include all such variations and modifications as fall within the spirit and the scope of the claims.

### BRIEF DESCRIPTION OF THE DRAWINGS

FIG. 1 is a flow diagram representing a method of providing restaurant services according to one embodiment of the invention.

FIGS. 2A, 2B, 2C, and 2D illustrate a flowchart demonstrating a method of providing restaurant services, according to one embodiment of the invention.

FIG. 3 illustrates a block diagram of a system for distributing information to and from restaurant patrons in a restaurant according to one embodiment of the invention.

FIG. 4 illustrates a block diagram demonstrating components that can be utilized in the devices shown in FIG. 3, according to one embodiment of the invention.

FIG. 5 illustrates a plan view of an exemplary restaurant in which restaurant services can be provided in accordance with one embodiment of the invention.

FIG. 6 illustrates an example of a display device that can be used by a patron at a restaurant table, according to one embodiment of the invention.

### DETAILED DESCRIPTION

When patrons sit at a restaurant table, they are typically cut off from normal lines of communication. This is particularly true when compared with the typical at-home dining experience where one can easily get up from the table and access information sources or obtain particular food items or drink items. However, when dining in a restaurant, the normal rules of etiquette are much different. The patron is typically limited to sitting at the table and not utilizing in many cases, a cell phone or paper. The reason for this is that such activities can often be distracting to other patrons and are thus discouraged by the management of the restaurant. Furthermore, the patron is often cut off from the waiter who is serving other tables. In addition, the patron may be cut off from superiors of the waiter and given no opportunity to comment on the service of the waiter who has been assigned to his or her table. As a result, the dining experience could be enhanced if the patron had more control over both information, and/or access to restaurant personnel. As a result, the patron would benefit and the restaurant would benefit by providing a more pleasurable dining experience.

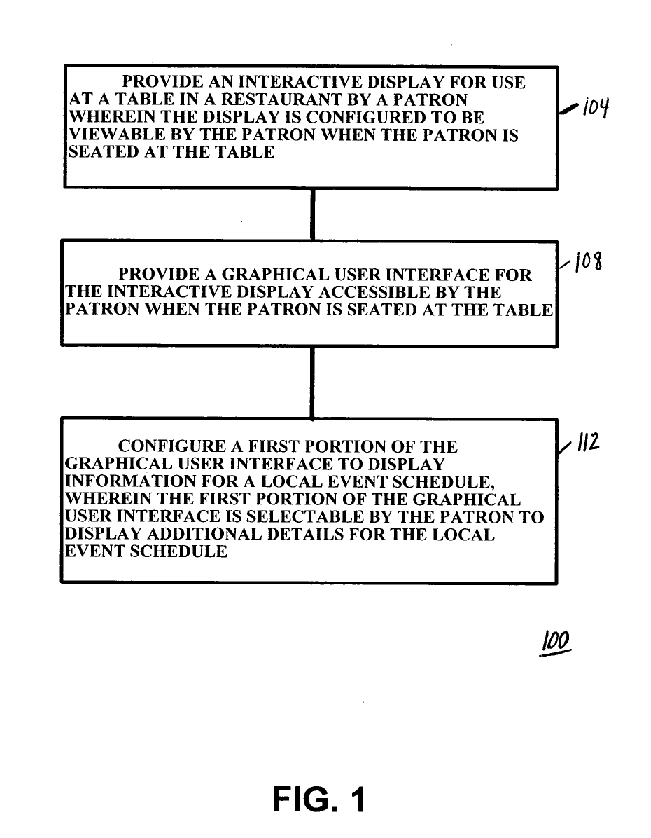

Thus, according to one embodiment, a system can be provided that allows a patron to obtain such information and/or access to restaurant personnel. For example, FIG. 1 illustrates a method according to one embodiment that allows a patron to obtain local event schedules while dining at a table in a restaurant. In accordance with this embodiment, a patron upon entering a restaurant or being seated at a restaurant is provided with an interactive display for use at the patron's table. The display is configured to be viewable by the patron while the patron is seated at the table. This is illustrated in block 104 of flowchart 100 shown in FIG. 1. The interactive display is provided with a graphical user interface for the patron's access during the time that the patron is seated at the table. This is shown in block 108. In addition, as shown in block 112, a first portion of the graphical user interface can be configured to display information for a local event schedule, wherein the first portion of the graphical user interface is selectable by the patron so as to display details for a local event schedule. One example of a local event schedule is a schedule listing theater events. Another example would be a schedule listing sporting events. Moreover, such schedules could be tailored so as to be local events which are readily accessible from the restaurant. For example, local events could be theater events taking place in a twenty mile radius of the restaurant over the upcoming couple of days, or more preferably, theater events taking place within a ten mile radius of the restaurant in the upcoming twenty-four hour period. Or, even more preferably, it could be theater events taking place within a three mile radius of the restaurant in the upcoming two hours. Thus, such a device would provide a patron at the restaurant with the opportunity to plan his or her schedule to take in such a theater event. Similarly, a sporting event schedule could be implemented if preferred by the patron.

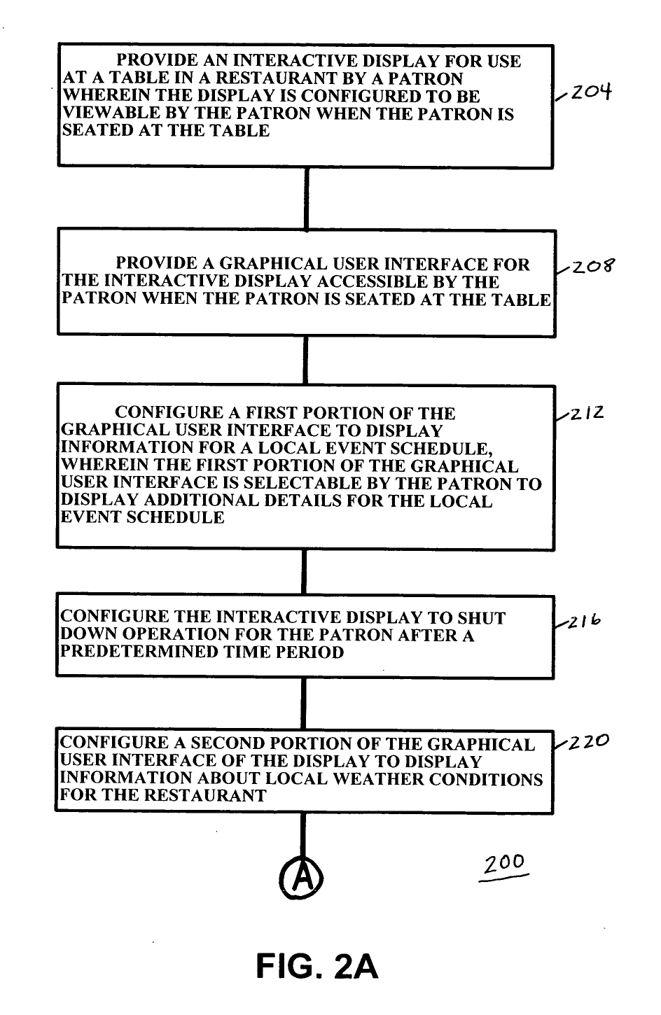

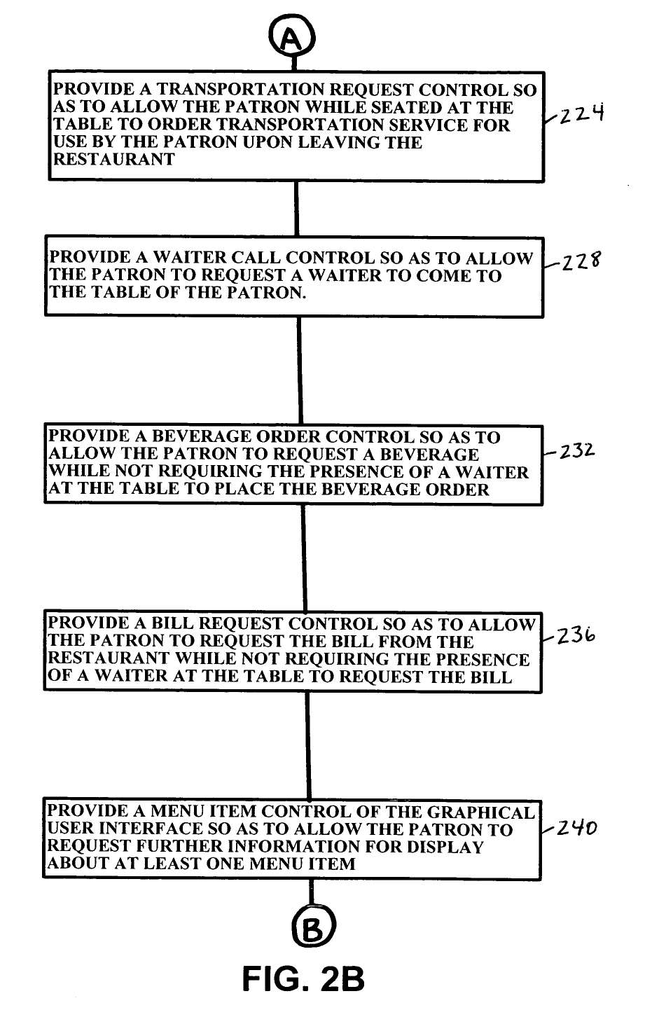

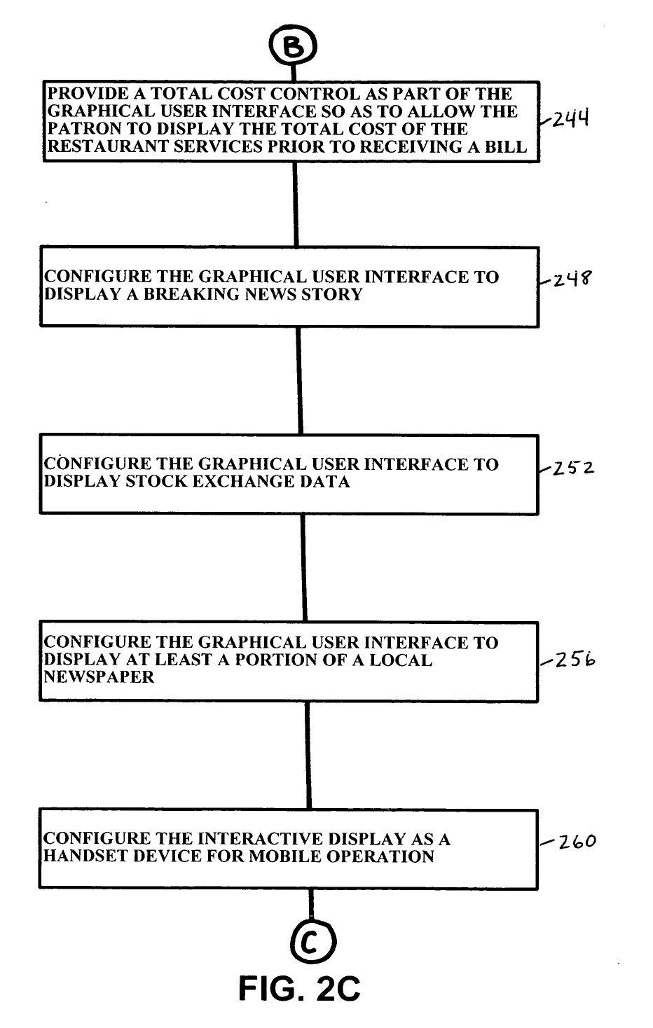

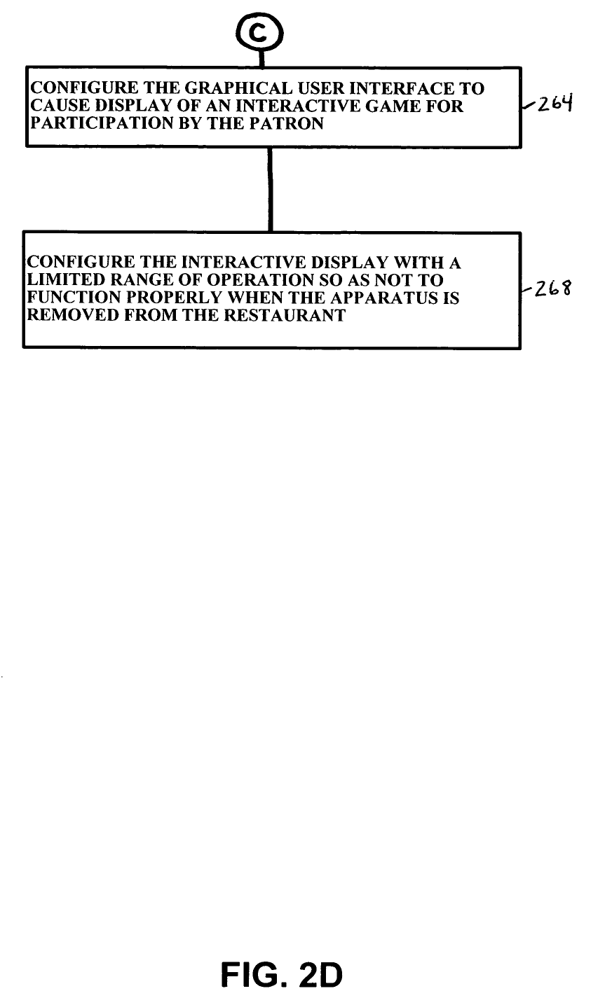

Referring now to flowchart 200 shown in FIGS. 2A, 2B, 2C, and 2D, additional embodiments of the invention are illustrated. These embodiments are shown as part of a combined flowchart. However, it should be understood that any function or any combination of functions illustrated in this example could be implemented as a separate embodiment of the invention. In block 204 an interactive display is provided for use at a patron's table. Typically, the patron would be provided with the interactive display at the time of entering the restaurant. Alternatively, the waiter or restaurant personnel could deliver the interactive display to the patron's table later during the dining experience. Still further, tables could be configured with interactive displays located at the table. Such displays could be configured so as to be mobile or alternatively attached to the table. It is envisioned that a handheld device would be preferred so as to provide mobile operation for the patron and to facilitate use at different seats at the table.

In block 208, the interactive display is configured with a graphical user interface (GUI) that is accessible by the patron when the patron is seated at the table. For example, such a graphical user interface could be a computer generated display selectable by the patron to display additional details for a local event schedule. One of ordinary skill in art will appreciate that a handheld device can be configured with a LCD display that can display a computer generated GUI that is selectable by a user through key strokes or stylus input, for example. Obviously, other physical arrangements could be utilized as well.

As noted earlier, a local event schedule could pertain to different areas of interest for a particular patron. For example, in implementing a graphical user interface that displays local theater information, this could be implemented by receiving information about at least one local theater event and configuring the first portion of the graphical user interface to display such information about the at least one theater event to the patron. Similarly, information about at least one local sporting event could be received and formatted for display on the first portion of the graphical user interface. Again, the patron could use a variety of input methods to select the desired content displayed on the graphical user interface.

Referring now to block 216, the interactive display can be configured to shut down operation for the patron after a predetermined time period. Thus, for example, the interactive display can utilize a timing operation performed by the processor of the interactive display so that after a set period of time, such as forty-five minutes, the interactive display will cease operating for the patron. A warning signal could be given so that the patron is not frustrated by the shut down operation. Such a shut down operation allows the restaurant to facilitate the rotation of the tables while still providing services for an individual patron. The restaurant does not want any patron to overstay his or her welcome where he is merely occupying a table beyond an expected time which would prevent additional patrons from occupying that table. To implement such a shut down feature, a timing operation in software code could be programmed so as to shut down the unit. Furthermore, restaurant personnel could power up a unit by entering a password that reinitiated the timing period when a new patron is seated at the restaurant. Similarly, the shut down period could be programmable, for example, so that the shut down period could be selectable by restaurant personnel.

Block 220 illustrates that a second portion of the graphical user interface of the interactive display can be configured to display information about local weather conditions for the restaurant. This allows a patron in an enclosed restaurant to obtain weather information and plan accordingly. For example, at a hotel restaurant, a patron who is able to determine that the current weather is raining outside the hotel restaurant can return to his or her hotel room and obtain an umbrella prior to departing the hotel. By being able to obtain the external weather conditions at the restaurant, the patron can plan ahead and leave enough time to return to the hotel room to obtain the umbrella, sweater, or coat. Similarly, a patron who knows it is raining outside can plan ahead and call a taxi rather than planning on walking to his or her next destination. Thus, the ability to determine the current weather conditions allows the patron to plan his or her activities accordingly and thus makes the patron more efficient in his or her activities.

In order to provide the weather information to the patron, the interactive display could be provided the weather information from a local source that continuously monitors and updates weather conditions for local geographic regions—for example, by area codes or by GPS coordinates via weather sensors. This information could be obtained by a weather data gathering service and stored on that service's server and downloaded via a computer network either directly or indirectly to a server at the restaurant. The restaurant server could then output the information for use on the restaurant's interactive display devices.

Block 224 illustrates that a transportation request control can be provided as part of the interactive display device so as to allow the patron, while seated at a table in the restaurant, to order transportation service for use by the patron upon leaving the restaurant. Such transportation could take the form of either valet service or taxi cab service, for example. In the example of valet service, the interactive device could be configured with either a graphical user interface control or a dedicated control configured as a physical part of the display device. The patron could request valet service with the device upon finishing his or her meal. The request would be transmitted, for example, from the interactive device to a computer server which would in turn forward the request to the valet operator. Alternatively, the request could be transmitted in an alternative way, such as directly from the patron's device to a valet device.

Similarly, a patron who needed taxi service could request a taxi from the handheld device by either selecting such a request via a graphical user interface on the interactive display device or via a dedicated control configured as part of the interactive device. Again, such a request could be transmitted from the patron's interactive device to a restaurant server. The restaurant server could then send a request to a taxi service via the internet. Alternatively, the request could be directed to the valet who in turn would take responsibility for obtaining the taxi.

Oftentimes while dining a patron would like to speak with the waiter. However, the waiter is frequently not in sight or easily within contact. This is due to the fact that the waiter is dealing with many other tables or in the kitchen obtaining food or otherwise occupied. However, the waiter is not necessarily occupied to such a degree that he or she could not come to the patron's table. In fact, a good waiter would like to know when a patron needs additional service so as to provide the best dining experience for that patron. This obviously makes the patron happier and thus provides a greater opportunity for the waiter to receive a bigger tip. Thus, block 228 illustrates that the interactive display can be provided with a waiter call control so as to allow the patron to request a waiter to come to the table of the patron. Again, this can be implemented either via a dedicated control that is configured as a physical part of the interactive device used by the patron, or it could be provided via a graphical user interface displayed on the interactive display device. The patron could merely activate the control and the interactive display device could transmit a signal to a unit utilized by the waiter. For example, a vibrating wireless unit could be carried by the waiter and configured to receive transmissions from the restaurant server. The patron's device would send a signal to the restaurant server and the restaurant server computer would transmit a message to the waiter's device indicating that the patron's table was in need of assistance. The waiter's device could operate in vibrate mode to notify the waiter when such a message was received.

Different types of requests could be sent to the waiter as well. This would prevent the need for the waiter to call on the table before bringing the requested item. For example, the interactive display device could be configured to display an icon for requesting a refill of the table's beverages. Alternatively, it could be configured with an icon to request coffee. Additionally, it could be configured to request a serving of water. Thus, block 232 illustrates that such beverage order requests could be implemented without requiring the waiter to first visit the table before bringing the requested items.

Block 236 illustrates a solution to a problem that frustrates many patrons. Namely, when a patron finishes his or her meal, they are ready to depart the restaurant. However, oftentimes, they have not yet received their bill. Thus, they must wait for the waiter to bring them the bill. As a result, they can become quite frustrated and this inconvenience can leave a negative impression of either the restaurant or the waiter. Thus, it is in the best interest of not only the patron, but the waiter and the restaurant as well, to provide a system that alleviates this inconvenience. Block 236 illustrates that the interactive display device can be configured to provide a bill request control so as to allow the patron to request the bill from the restaurant while not requiring the presence of a waiter at the table in order to request the bill. Again, this operates along the same principles illustrated above in that the interactive display device can be configured with a control that allows this request to be made and communicated to the waiter or communicated to other restaurant personnel. The waiter and restaurant personnel can receive the signal and fulfill the request accordingly.

Block 240 illustrates that menu information can also be provided to the patron via the interactive display device. As one example, a menu item control can be provided as part of the graphical user interface so as to allow the patron to request further information for display about at least one menu item. For example, the patron could drill down about a specific menu item to determine specific ingredients utilized as part of a specific dish, or portion size, or cost. For example, some patrons will have certain dietary requirements that prevent them from eating particular types of food. As one example, some patrons may be on a gluten free diet, in which case they cannot eat items containing certain wheat products. By providing additional menu information about a particular dish, a patron can satisfy himself or herself that a dish will not cause an allergic reaction. Similarly, the patron may want to obtain a recipe for making a dish that they have enjoyed while dining at the restaurant. Thus, they can obtain such information either before or after ordering the item. Again, this can be implemented via the graphical user interface provided at the interactive display device.

Block 244 illustrates that a patron may want to obtain the total cost expected for a meal prior to receiving a bill. This is different from requesting that the bill be brought to the patron's table as mentioned earlier. Rather, this function allows the patron to receive a current total of the cost for a meal prior to the meal being completed. A patron may want to stay within a particular budget for a meal and need this information prior to ordering additional items. In addition, a patron may want to know the total for a meal so that they can discuss an appropriate tip with their spouse prior to the waiter delivering the check to the table and standing within hearing distance while they discuss the tip. Thus, this provides a convenience for the patron in that he or she can obtain the current cost when they desire it.

For a patron dining alone or even dining with others, the interactive display device described above can also be used to provide news information to the patron. This gives the patron something to occupy his or her time with while dining. Thus, block 248 illustrates that the graphical user interface can be configured to display breaking news stories. Similarly, block 252 illustrates that the graphical user interface can be configured to display stock exchange data. In addition, block 256 illustrates that the graphical user interface can be configured to display information from a local newspaper. Such information can be accessed and perused by a patron during a meal. Such information content could be downloaded from the internet to the restaurant server and then distributed to the interactive display device.

While the interactive display device could be configured as a substantially permanent portion of a table at a restaurant, it is preferably a mobile handset that can be held by the patron. This facilitates interactive use of the device in a convenient manner as well as visualizing details that might be difficult to see from across the table. Furthermore, a mobile unit facilitates use at different seats at a particular table. For example, the unit could be configured to play interactive games via the graphical user interface. For multiple players, the unit could then be easily exchanged if it were a mobile unit as opposed to a substantially fixed unit as part of the table. Thus, block 260 illustrates that the interactive display could be a handset device, while block 264 illustrates that the device could also be configured so as to cause display of an interactive game for participation by the patron.

Block 268 illustrates that the device can be configured to cease operation when taken outside of the restaurant. Generally, this can be implemented by configuring the transmitter that transmits to the interactive device to have a limited transmission range that does not extend significantly beyond the geographic area of the restaurant. Alternatively, it could be implemented by configuring the interactive device with a GPS unit that transmits location information back to the transmitter so that the transmitter can determine when the interactive display device has been removed from the geographic limits of the restaurant. In response, the transmitter can cease transmitting to the unit or send a shut down signal. Other implementations could be utilized as well, as would be understood by those of ordinary skill in the art. This capability prevents a patron from trying to walk off with the interactive device and utilize its services outside of the restaurant. Thus, it will deter patrons from walking off with the interactive devices.

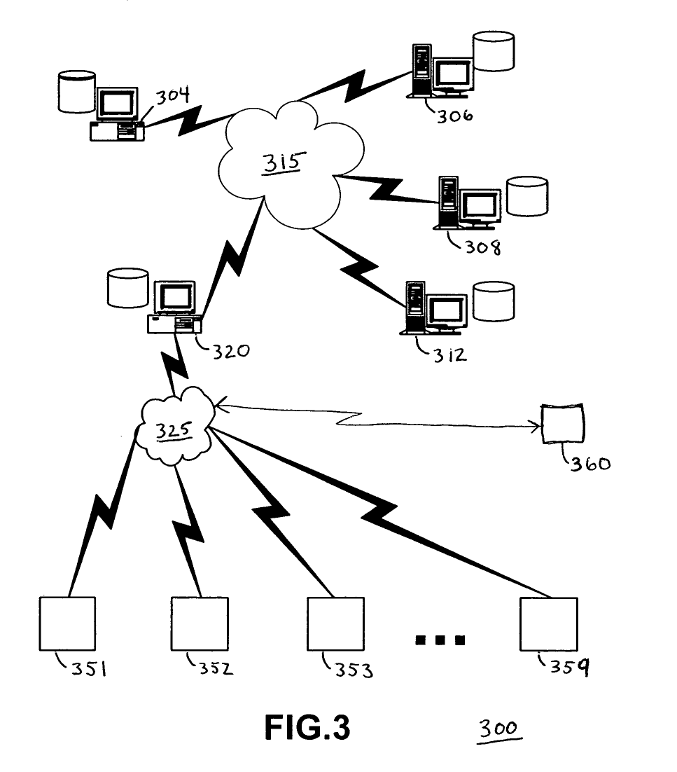

Referring now to FIG. 3, a system 300 for implementing the methods described above is illustrated, according to one embodiment of the invention. FIG. 3 shows an example where content can be provided to a restaurant computer 320 from multiple information sources. For example, computer 304 can obtain local event information via a network 315, such as the internet, and external information computers 306, 308, and 312. For example, computer 306 may store information for upcoming local events. Computer 304 can gather and parse this information for a specific restaurant location. This could be implemented for example, based on postal codes for a restaurant and for local theaters. Similarly, it could be implemented for sporting event venues and for local restaurants by postal code. The computer 304 can gather and assimilate the data and communicate it to restaurant computer 320 via network 315. The restaurant computer 320 can then distribute the information to the interactive display devices used in the restaurant, namely, devices 351, 352, 353, and 359. The interactive display devices are given to patrons at the restaurant for their use. As described above, these devices can receive and transmit signals from and to computer 320, respectively. For example, this could be implemented via wireless network 325. Alternatively, it could be implemented via a hardwired system in which the interactive devices are stationed at the tables of the restaurant and cabled back to the computer 320. FIG. 3 also shows an interactive device 360 which can be carried by restaurant personnel. This allows the patron's device to signal restaurant personnel—who can include not only the waiter, but also the maitre 'd, restaurant manager, or valet. In some instances, a patron may desire to page the manager to complain about the food or service. Thus, the system can be extended to accommodate that functionality by providing such a control as part of the interactive device used by the patrons.

Similarly, computers 306, 308, and 312 can represent other external sources of data or services. For example, they could be taxi cab computers that receive requests for taxi service at the restaurant when a patron makes such a request. In addition, they could be the source of newspaper articles, breaking news stories, stock exchange or financial data, interactive games, menu information, or event information.

In addition, according to one embodiment, restaurant computer 320 could obtain such information by itself and perform the function of computer 304 mentioned above.

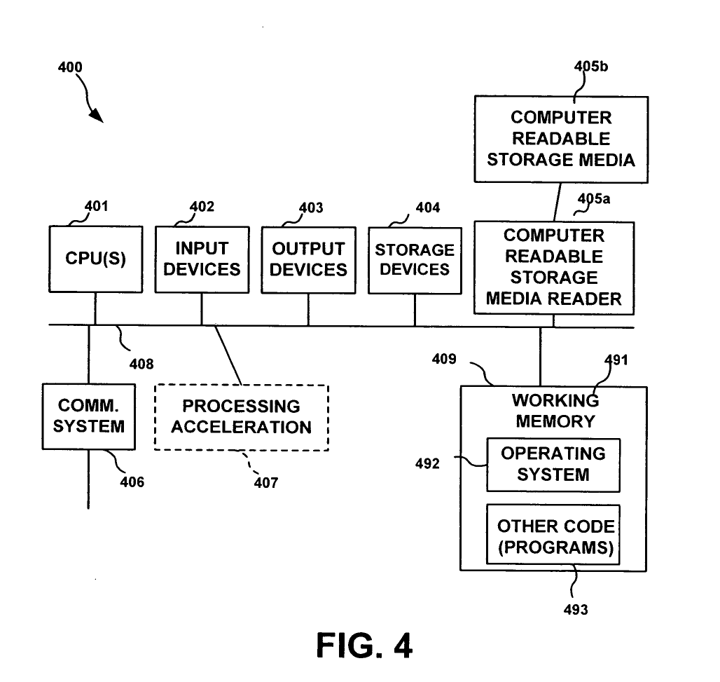

FIG. 4 broadly illustrates an example of how individual system elements in FIG. 3 can be implemented. System 400 is shown comprised of hardware elements that are electrically coupled via bus 408, including a processor 401, input device 402, output device 403, storage device 404, computer-readable storage media reader 405a, communications system 406 processing acceleration (e.g., DSP or special-purpose processors) 407 and memory 409. Computer-readable storage media reader 405a is further coupled to computer-readable storage media 405b, the combination comprehensively representing remote, local, fixed and/or removable storage devices plus storage media, memory, etc. for temporarily and/or more permanently containing computer-readable information, which can include storage device 404, memory 409 and/or any other such accessible system 400 resource. System 400 also comprises software elements (shown as being currently located within working memory 491) including an operating system 492 and other code 493, such as programs, applets, data and the like.

System 400 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 400 component (e.g. within communications system 406). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) Not all system 400 components will necessarily be required in all cases.

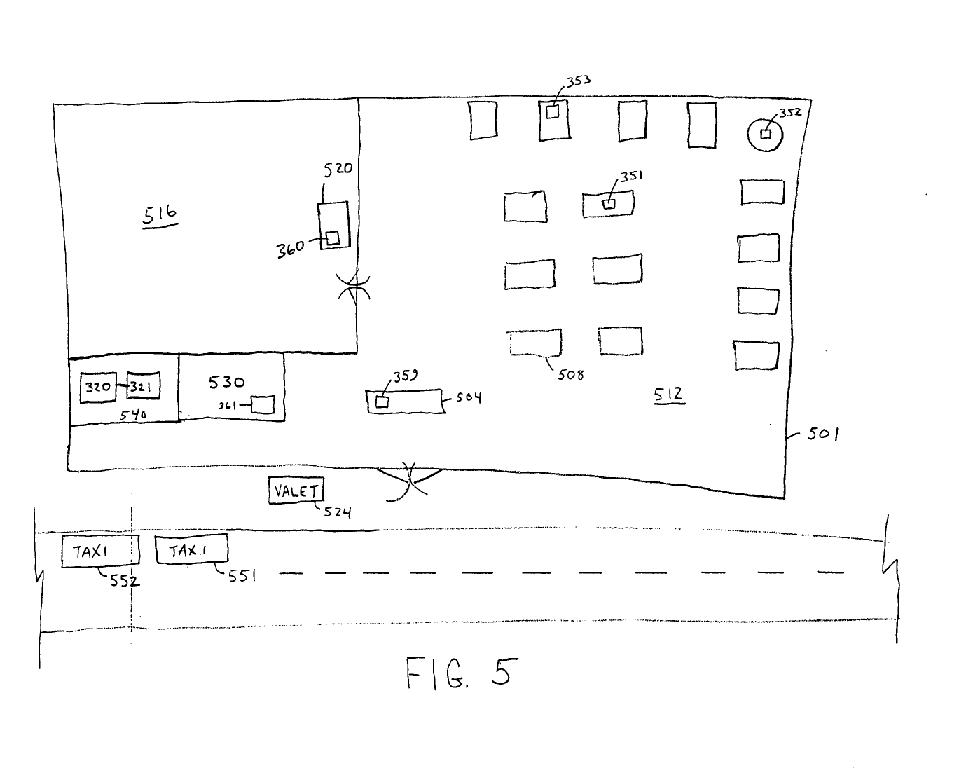

FIG. 5 illustrates a plan view of a restaurant in which the system illustrated above can be implemented according to one embodiment. A patron upon entering restaurant 501 will be greeted by the maitre 'd or hostess at reception area 504. The reception area can be used to store interactive display devices such as mobile hand sets that are provided to the patron. FIG. 5 illustrates such a mobile hand set 359 being stored at the reception area. FIG. 5 illustrates that several devices are already in operation at different tables 508 in the restaurant. For example, units 351, 352, and 353 are shown at tables according to this example. When a patron in dining area 512 wishes to page a waiter in kitchen area 516 the interactive devices can be utilized to send a wireless transmission signal to computer 320 in computer room 540 via transceiver 321. The transceiver can relay the signal to the waiter's device 360 at serving preparation station 520 in kitchen 516.

Similarly, when the patron desires to page the restaurant manager in office 530, the signal can be relayed to device 361 in order to signal the manager.

When the patron desires to signal for valet service, the signal can be relayed from the patron's device to valet station 524. The valet can determine the automobile for that particular patron associated with a particular paging device and obtain the automobile for the patron so that it is ready as the patron departs the restaurant.

Similarly, the patron can request taxi service by signaling restaurant computer 320 which contacts a taxi service via the internet and causes a taxi driver to go to the restaurant as illustrated by taxi 551. Alternatively, for a restaurant with valet service, the request could go to the valet who would hail a taxi 552 via phone or from the street.

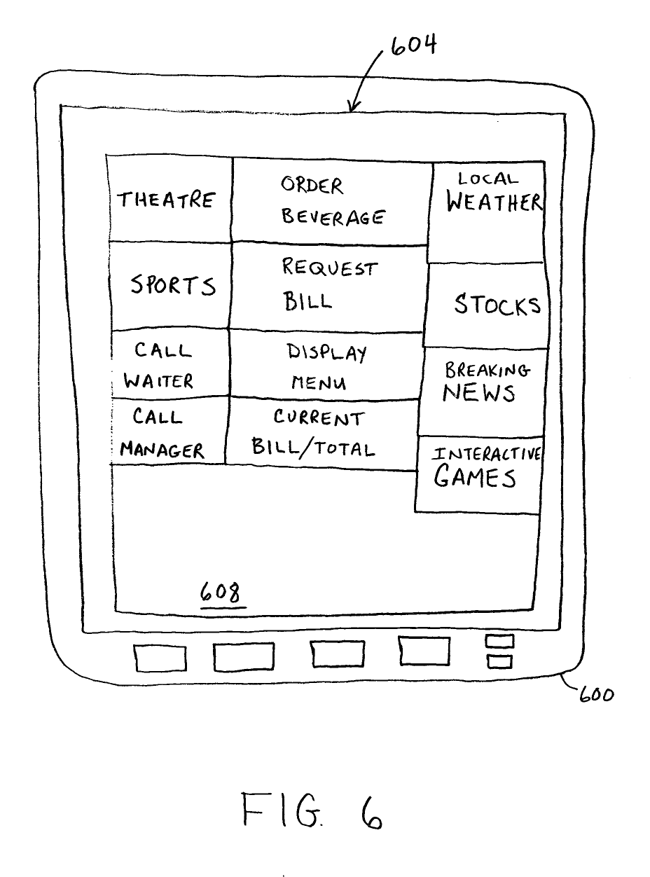

FIG. 6 illustrates an example of an interactive display device that can be given to a patron. Device 600 in FIG. 6 includes a display 604, such as an LCD display. The display in this example includes a GUI 608. The GUI is shown as being divided into different sections to provide different selectable control options for the patron. Thus, this particular example provides a portion of the GUI for selecting a local theatre events schedule, local sporting events schedule, calling a waiter, calling the manager, ordering a beverage, requesting the bill, displaying the menu, requesting the current bill items and/or total (e.g., to confirm that an order was placed correctly), as well as viewing local weather conditions, stock information, breaking news stories, and selecting interactive games. Selection of a particular part of the graphical user interface can trigger additional screens for providing additional controls for the selected subject area, as would be understood by one of ordinary skill in the art. A device such as that shown in FIG. 6 could be implemented via a circuit such as that shown in FIG. 4.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well. Furthermore, the embodiments of the invention may be embodied as code stored in a computer-readable memory of virtually any kind including, without limitation, RAM, ROM, magnetic media, optical media, or magneto-optical media. Even more generally, the embodiments of the invention could be implemented in software, or in hardware, or any combination thereof including, but not limited to, software running on a general purpose processor, microcode, PLAs, or ASICs.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents.

It is thought that the apparatuses and methods of the embodiments of the present invention and its attendant advantages will be understood from this specification. While the above is a complete description of specific embodiments of the invention, the above description should not be taken as limiting the scope of the invention as defined by the claims.

What is claimed is:

1. A method of providing information for use by a patron of a restaurant at a table of the patron, the method comprising:
providing an interactive display for use at a table in a restaurant wherein said display is configured to be viewable by said patron when said patron is seated at said table;
providing a graphical user interface for said interactive display accessible by said patron when said patron is seated at said table;
configuring a first portion of said graphical user interface to display information for a local event schedule, wherein said first portion of said graphical user interface is selectable by said patron to display additional details for said local event schedule.

2. The method as claimed in claim 1 and further comprising:
configuring said interactive display to shut down operation for said patron after a predetermined time period.

3. The method as claimed in claim 1 and further comprising:
configuring a second portion of said graphical user interface of said display to display information about local weather conditions for said restaurant.

4. The method as claimed in claim 1 wherein said configuring said first portion of said graphical user interface to display information for said local event schedule comprises:
receiving information about at least one local theatre event; and
configuring said first portion of said graphical user interface to display said information about said at least one local theatre event.

5. The method as claimed in claim 1 wherein said configuring said first portion of said graphical user interface to display information for said local event schedule comprises:
receiving information about at least one local sporting event; and
configuring said first portion of said graphical user interface to display said information about said at least one local sporting event.

6. The method as claimed in claim 1 wherein said configuring said first portion of said graphical user interface to display information for said local event schedule comprises:
receiving information about at least one local news story; and
configuring said first portion of said graphical user interface to display said information about said at least one local news story; and
providing a control so as to allow said patron to select further information about said local news story.

7. The method as claimed in claim 1 and further comprising:
providing a transportation request control so as to allow said patron while seated at said table to order transportation service for use by said patron upon leaving said restaurant.

8. The method as claimed in claim 1 and further comprising:
providing a waiter call control so as to allow said patron to request a waiter to come to said table of said patron.

9. The method as claimed in claim 1 and further comprising:
providing a beverage order control so as to allow said patron to request a beverage while not requiring the presence of a waiter at said table to place the beverage order.

10. The method as claimed in claim 1 and further comprising:
providing a bill request control so as to allow said patron to request the bill from said restaurant while not requiring the presence of a waiter at said table to request said bill.

11. The method as claimed in claim 1 and further comprising:
providing a menu item control of said graphical user interface so as to allow said patron to request further information for display about at least one menu item.

12. The method as claimed in claim 1 and further comprising:
providing a total cost control as part of said graphical user interface so as to allow said patron to display the total cost of the restaurant services prior to receiving a bill.

13. The method as claimed in claim 1 and further comprising:
configuring said graphical user interface to display a breaking news story.

14. The method as claimed in claim 1 and further comprising:
configuring said graphical user interface to display stock exchange data.

15. The method as claimed in claim 1 and further comprising:
configuring said graphical user interface to display at least a portion of a local newspaper.

16. The method as claimed in claim 1 and further comprising:
configuring said interactive display as a handset device for mobile operation.

17. The method as claimed in claim 1 and further comprising:
configuring said graphical user interface to cause display of an interactive game for participation by said patron.

18. The method as claimed in claim 1 and further comprising:
configuring said interactive display with a limited range of operation so as not to function properly when said apparatus is removed from said restaurant.

19. An apparatus for providing information to a patron of a restaurant at a table of the restaurant, the apparatus comprising:
an input to receive content information;
a memory coupled with said input to store said content information;
a display;
a processor coupled with said memory and said display and configured to cause display of a graphical user interface accessible by said patron when said patron is seated at said table and wherein said processor is configured to cause display of a first portion of said graphical user interface so as to display information for a local event schedule and wherein said first portion of said graphical user interface is selectable by said patron to display additional details for said local event schedule.

20. The apparatus as claimed in claim 19 wherein said apparatus is configured to shut down operation for said patron after a predetermined time period.

21. The apparatus as claimed in claim 19 wherein a second portion of said graphical user interface of said display is configured to display information about local weather conditions for said restaurant.

22. The apparatus as claimed in claim 19 wherein said first portion of said graphical user interface configured to display information for said local event schedule is configured to allow selection of information about at least one local theatre event.

23. The apparatus as claimed in claim 19 wherein said first portion of said graphical user interface configured to display information for said local event schedule is configured to allow selection of information about at least one local sporting event.

24. The apparatus as claimed in claim 19 wherein said processor is further configured to cause display of a local news portion of said graphical user interface.

25. The apparatus as claimed in claim 19 and further comprising:
a transportation request control so as to allow said patron while seated at said table to order transportation service for use by said patron upon leaving said restaurant.

26. The apparatus as claimed in claim 19 and further comprising:
a waiter call control so as to allow said patron to request a waiter to come to said table of said patron.

27. The apparatus as claimed in claim 19 and further comprising:
a beverage order control so as to allow said patron to request a beverage while not in the presence of a waiter.

28. The apparatus as claimed in claim 19 a bill request control so as to allow said patron to request the bill from said restaurant while not in the presence of a waiter.

29. The apparatus as claimed in claim 19 wherein said processor is further configured to cause display of a menu item control portion of said graphical user interface so as to allow said patron to request further information about at least one menu item.

30. The apparatus as claimed in claim 19 wherein said processor is further configured to cause display of a total cost control portion of said graphical user interface so as to allow said patron to view the total cost of the bill prior to receiving the bill.

31. The apparatus as claimed in claim 19 wherein said processor is further configured to cause display of information concerning a breaking news story.

32. The apparatus as claimed in claim 19 wherein said processor is further configured to cause display of stock exchange data.

33. The apparatus as claimed in claim 19 wherein said processor is further configured to cause display of at least a portion of a local newspaper.

34. The apparatus as claimed in claim 19 wherein said apparatus is configured as a handset device for mobile operation.

35. The apparatus as claimed in claim 19 wherein said processor is further configured to cause display of an interactive game for participation by said patron.

36. The apparatus as claimed in claim 19 wherein said apparatus is configured with a limited range of operation so as not to function properly when said apparatus is removed from said restaurant.

37. A method of providing information for use by a patron of a restaurant at a table of the patron, the method comprising:
providing an interactive display at a table in a restaurant wherein said display is configured to be viewable by said patron when said patron is seated at said table;
providing a graphical user interface for said interactive display accessible by said patron when said patron is seated at said table;
configuring a first portion of said graphical user interface to display information for a local theatre event schedule, wherein said first portion of said graphical user interface is selectable by said patron to display additional details for said local theatre event schedule;
configuring a second portion of said graphical user interface to display information for a local sporting event schedule, wherein said second portion of said graphical user interface is selectable by said patron to display additional details for said local sporting event schedule;
configuring a third portion of said graphical user interface of said display to display information about local weather conditions for said restaurant;
configuring a fourth portion of said graphical user interface of said display to display information about at least one local news story, wherein said fourth portion of said graphical user interface is selectable by said patron to display further information about said local news story;
providing a transportation request control so as to allow said patron while seated at said table to order transportation service for use by said patron upon leaving said restaurant;
providing a waiter call control so as to allow said patron to request a waiter to come to said table of said patron;
providing a beverage order control so as to allow said patron to request a beverage while not requiring the presence of a waiter at said table to place the beverage order;
providing a bill request control so as to allow said patron to request the bill from said restaurant while not requiring the presence of said waiter at said table to request said bill;
providing a menu item control of said graphical user interface so as to allow said patron to request further information about at least one menu item;
providing a total cost control as part of said graphical user interface so as to allow said patron to view the total cost of the bill prior to receiving the bill.
